(19) United States
(12) Patent Application Publication
(10) Pub. No.: US 2024/0129434 A1
(43) Pub. Date: Apr. 18, 2024

(54) PRESENTING CONTEXTUAL INFORMATION REGARDING AUDIO AND/OR VIDEO DATA OUTPUT FROM A USER DEVICE DURING A LIVE WEB CONFERENCE

(71) Applicant: International Business Machines Corporation, Armonk, NY (US)

(72) Inventors: Zachary A. Silverstein, Georgetown, TX (US); Melanie Dauber, Oceanside, NY (US); Jacob Ryan Jepperson, St. Paul, MN (US); Jeremy R. Fox, Georgetown, TX (US)

(21) Appl. No.: 17/966,647

(22) Filed: Oct. 14, 2022

(51) Int. Cl. H04N 7/15; G06F 40/20; H04L 12/18; H04N 7/14

(52) U.S. Cl. CPC H04N 7/152; G06F 40/20; H04L 12/1822; H04N 7/147

(57) ABSTRACT

A computer-implemented method, according to one embodiment, includes monitoring, during a live web conference, audio and video data associated with participants of the live web conference. The participants include at least a first participant and a second participant. The method further includes analyzing the first participant's behavior to determine whether to classify the first participant's behavior as being indicative of sound-aware actions, and presenting information, based on the analysis, on a first user device of the first participant regarding audio and/or video data output from the first user device. A computer program product, according to another embodiment, includes a computer readable storage medium having program instructions embodied therewith. The program instructions are readable and/or executable by a computer to cause the computer to perform the foregoing method.

### BACKGROUND

The present invention relates to live web conferences, and more specifically, this invention relates to determining and presenting contextual information regarding audio and/or video data output from a user device during a live web conference.

Conferencing platforms, e.g., such as web-based conferencing applications, video-based conferencing applications, videotelephony software programs, etc., are attended by participants to communicate audibly and in some cases visually with one another. This enables such participants to establish a communication session, e.g., hereafter referred to as a “live web conference,” while the participants are geographically located in different locations. During a live web conference on such conferencing platforms, participants are often presented with selectable options that allow their audio outputs to be selectively enabled, e.g., muted or unmuted, as well as their video outputs to be selectively enabled, e.g., video off or video on.

### SUMMARY

A computer-implemented method according to one embodiment includes monitoring, during a live web conference, audio and video data associated with participants of the live web conference. The participants include at least a first participant and a second participant. The method further includes analyzing the first participant's behavior to determine whether to classify the first participant's behavior as being indicative of sound-aware actions, and presenting information, based on the analysis, on a first user device of the first participant regarding audio and/or video data output from the first user device.

A computer program product according to another embodiment includes a computer readable storage medium having program instructions embodied therewith. The program instructions are readable and/or executable by a computer to cause the computer to perform the foregoing method.

A system according to another embodiment includes a processor, and logic integrated with the processor, executable by the processor, or integrated with and executable by the processor. The logic is configured to perform the foregoing method.

Other aspects and embodiments of the present invention will become apparent from the following detailed description, which, when taken in conjunction with the drawings, illustrate by way of example the principles of the invention.

### BRIEF DESCRIPTION OF THE DRAWINGS

FIG. 1 is a diagram of a computing environment, in accordance with one embodiment of the present invention.

FIG. 2 is a flowchart of a method, in accordance with one embodiment of the present invention.

FIGS. 3A-3C depict a user device display, in accordance with one embodiment of the present invention.

### DETAILED DESCRIPTION

The following description is made for the purpose of illustrating the general principles of the present invention and is not meant to limit the inventive concepts claimed herein. Further, particular features described herein can be used in combination with other described features in each of the various possible combinations and permutations.

Unless otherwise specifically defined herein, all terms are to be given their broadest possible interpretation including meanings implied from the specification as well as meanings understood by those skilled in the art and/or as defined in dictionaries, treatises, etc.

It must also be noted that, as used in the specification and the appended claims, the singular forms “a,” “an” and “the” include plural referents unless otherwise specified. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The following description discloses several preferred embodiments of systems, methods and computer program products for determining and presenting contextual information regarding audio and/or video data output from a user device during a live web conference.

In one general embodiment, a computer-implemented method includes monitoring, during a live web conference, audio and video data associated with participants of the live web conference. The participants include at least a first participant and a second participant. The method further includes analyzing the first participant's behavior to determine whether to classify the first participant's behavior as being indicative of sound-aware actions, and presenting information, based on the analysis, on a first user device of the first participant regarding audio and/or video data output from the first user device.

In another general embodiment, a computer program product includes a computer readable storage medium having program instructions embodied therewith. The program instructions are readable and/or executable by a computer to cause the computer to perform the foregoing method.

In another general embodiment, a system includes a processor, and logic integrated with the processor, executable by the processor, or integrated with and executable by the processor. The logic is configured to perform the foregoing method.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as contextual information analysis management of block 200 for determining and presenting contextual information regarding audio and/or video data output from a user device during a live web conference. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

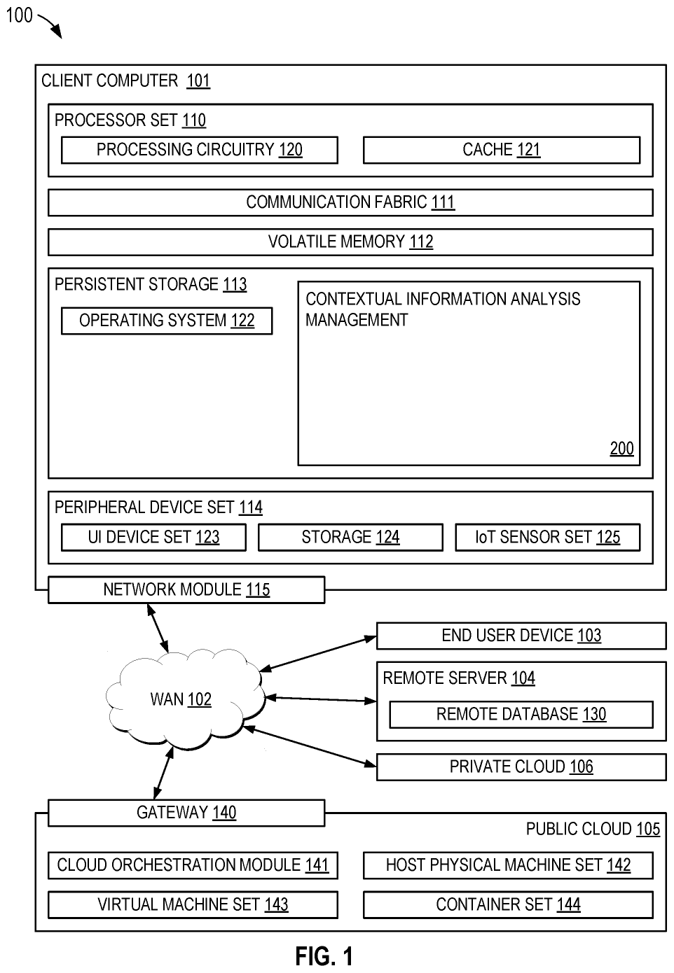

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

In some aspects, a system according to various embodiments may include a processor and logic integrated with and/or executable by the processor, the logic being configured to perform one or more of the process steps recited herein. The processor may be of any configuration as described herein, such as a discrete processor or a processing circuit that includes many components such as processing hardware, memory, I/O interfaces, etc. By integrated with, what is meant is that the processor has logic embedded therewith as hardware logic, such as an application specific integrated circuit (ASIC), a FPGA, etc. By executable by the processor, what is meant is that the logic is hardware logic; software logic such as firmware, part of an operating system, part of an application program; etc., or some combination of hardware and software logic that is accessible by the processor and configured to cause the processor to perform some functionality upon execution by the processor. Software logic may be stored on local and/or remote memory of any memory type, as known in the art. Any processor known in the art may be used, such as a software processor module and/or a hardware processor such as an ASIC, a FPGA, a central processing unit (CPU), an integrated circuit (IC), a graphics processing unit (GPU), etc.

Of course, this logic may be implemented as a method on any device and/or system or as a computer program product, according to various embodiments.

As mentioned elsewhere herein, conferencing platforms, e.g., such as web-based conferencing applications, video-based conferencing applications, videotelephony software programs, etc., are attended by participants to communicate audibly and in some cases visually with one another. This enables such participants to establish a communication session, e.g., hereafter referred to as a “live web conference,” while the participants are geographically located in different locations. During a live web conference on such conferencing platforms, participants are often presented with selectable options that allow their audio outputs to be selectively enabled, e.g., muted or unmuted, as well as their video outputs to be selectively enabled, e.g., video off or video on.

Today, when using conferencing platforms, there is often a disconnect between the hardware, the software and the user experience. For example, a user may place themselves on mute as they believe there is a distracting noise in their background from construction, and as a result the user may end up not contributing as much as they intended to the discussion as they are constantly looking out the window or distracted. Some conferencing platforms may include technological features that abstract background noise so that none of the participants on the call with the user can hear the user's construction background noise. The user may however remain unaware of whether this feature is working, and therefore opt to remain on mute when not actively speaking on the call. This is distracting to the user and potentially other participants that watch the user distracted by the construction. The user toggling between being muted and unmuted is also distracting. Accordingly, there is a need for providing users a way to be made aware whether others in a live web conference can hear the user's background noises.

In sharp contrast to the numerous deficiencies described above, techniques of various embodiments and approaches described herein include enabling a live web conference platform, e.g., module, that is configured to detect observable images, partner them with feedback of audio, and scenario-based context to make a correlation that is notified to a user with a recommendation of whether the user should be muted or unmuted.

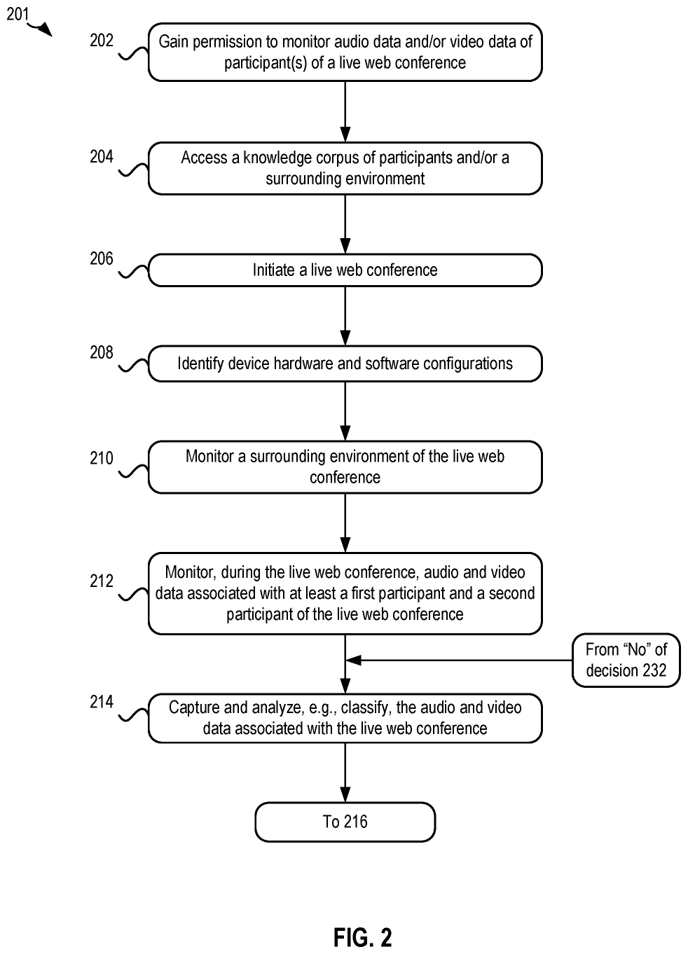

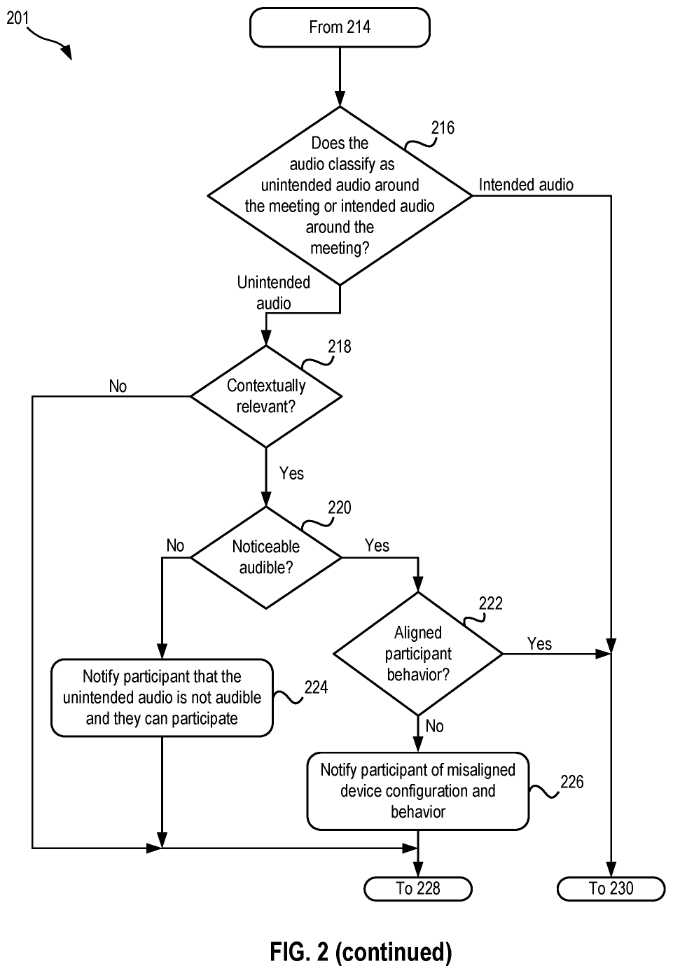

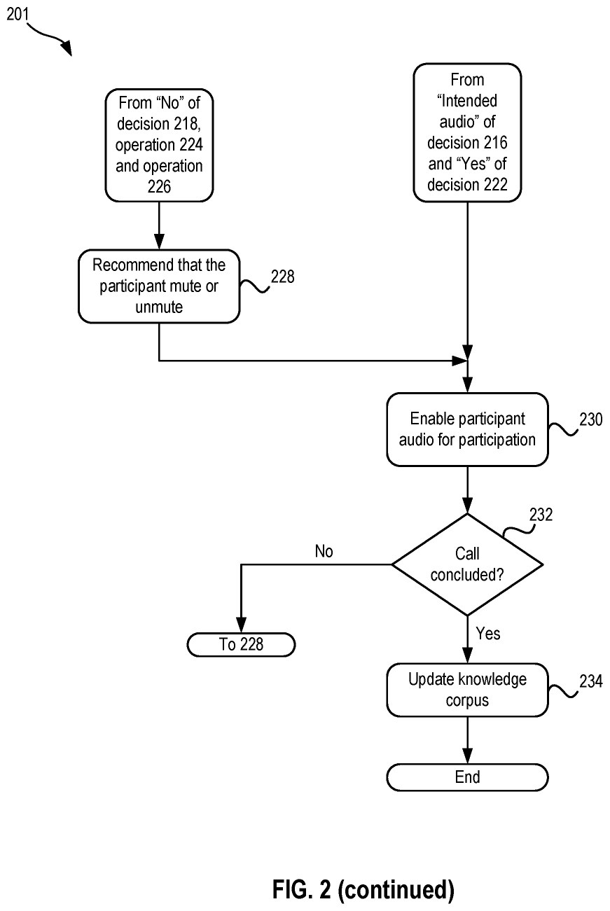

Now referring to FIG. 2, a flowchart of a method 201 is shown according to one embodiment. The method 201 may be performed in accordance with the present invention in any of the environments depicted in FIGS. 1-3C, among others, in various embodiments. Of course, more or fewer operations than those specifically described in FIG. 2 may be included in method 201, as would be understood by one of skill in the art upon reading the present descriptions.

Each of the steps of the method 201 may be performed by any suitable component of the operating environment. For example, in various embodiments, the method 201 may be partially or entirely performed by a computer, or some other device having one or more processors therein. The processor, e.g., processing circuit(s), chip(s), and/or module(s) implemented in hardware and/or software, and preferably having at least one hardware component may be utilized in any device to perform one or more steps of the method 201. Illustrative processors include, but are not limited to, a central processing unit (CPU), an application specific integrated circuit (ASIC), a field programmable gate array (FPGA), etc., combinations thereof, or any other suitable computing device known in the art.

It may be prefaced that method 201 includes various operations that involve monitoring a user and/or data associated with a user, e.g., user behavior, audio data, video data, etc. In preferred approaches, such monitoring is performed only subsequent to gaining permission from a user associated with the monitoring. For example, a user associated with the monitoring may include a first participant using a user device and/or any other participants that the first participant is on a live web conference with. Accordingly, operation 202 of method 201 includes gaining permission to monitor audio data and/or video data of participant(s) of a live web conference. For context, a live web conference may include any known type of, e.g., audio call, video call, web-based conference, cellular-based conference, hardline feed-based conference, etc., that may include any number of participants communicating via user devices. The live web conference may, in some approaches, be hosted on a communication application that is preferably configured to host a plurality of participants, e.g., two, three, four, twenty, fifty, etc., where each participant can view their own video feed and/or the video and audio feed of a plurality of other participants. In one approach, such permission may be gained subsequent to issuing a request for permission to one or more participants. In another approach, such permission may be obtained by the participant(s) opting into a service associated with the techniques of various embodiments and/or approaches described herein.

A knowledge corpus of participants and/or a surrounding environment is accessed in some approaches, e.g., see operation 204. The knowledge corpus may include information associated with previous analysis of one or more participants on a live web conference. For example, in some approaches, the knowledge corpus is a table of information that is based on past iterations of one or more operations of method 201 being performed. For example, the knowledge corpus may include information such as a previous number of times that it has been recommended that a participant mute themself in response to unintended audio feedback propagating through to other participants while on a live web conference. In some other approaches, the knowledge corpus may include information such as information manually input by a participant into a communication device that details an amount of background noise that the participant is comfortable potentially being sent to other participants while on a live web conference. For example, in environments where relatively more participants are on the live web conference it may be preferable to minimize all background noise because of feedback that may result from a plurality of users contributing background noise on a live web conference, e.g., based on a contributory effect. In contrast, in environments where relatively few participants are on the live web conference, e.g., such as only two participants total, relatively more background noise may be listed as acceptable in the knowledge corpus. This information may be used as contextual information in analysis steps described elsewhere herein, e.g., see operation 214.

Operation 206 includes initiating a live web conference. The live web conference may be initiated by outputting a call to a plurality of device used by a plurality of different participants. In some approaches, the live web conference may have been previously scheduled, and accordingly, initiating the live web conference may include establishing a live web conference platform, e.g., a session on a communication application, for the participants to virtually meet on. For context, it should be noted that various operations of method 201 may be performed by, and therefore described from the perspective of a device of a participant, e.g., hereafter referred to as “the first participant” and the “user device of the first participant” or “first user device” The first participant is preferably a person, and the user device of the first participant may be a known type of communication device, e.g., a phone, a tablet, a computer, etc. Furthermore, during the live web conference, participants of the live web conference preferably include at least the first participant and a second participant, e.g., communicating using the user device of the first participant and a user device of the second participant.

Device hardware and software configurations, e.g., of the user devices being used by participants to attend the live web conference, are identified, e.g., see operation 208. In some approaches, the device hardware may include hardware features of the user device, e.g., microphone(s), camera(s), displays, fingerprint sensors, temperature sensors, motion sensors, global positioning system (GPS) components, etc. The software configurations may include, e.g., a release version of the application that the live web conference is being performed using, audio filtering configurations, sound detection software configurations, muting options, etc. Information associated with the identified hardware and/or software configurations may be used to determine whether a user device is capable of filtering background sound out from audio and/or video data being output from the user device of the first participant to at least the user device of the second participant. This information may be considered in the analysis operation in order to determine whether to recommend to that the first participant be muted or unmuted, e.g., see operation 214 and operation 224.

In some approaches, a surrounding environment of the live web conference may be monitored, e.g., see operation 210. This monitoring may be performed in order to determine a nature of noise that may be present in audio and/or video data that is output from the user device of the first participant. For example, in order to determine whether to expect construction noise in the audio and/or video data that is output from the user device of the first participant, building permits may be checked to determine whether a building that the user is located in and/or alternatively within a proximity of is undergoing a remodel. In another example, monitoring a surrounding environment of the live web conference may include monitoring a GPS location of the user device, and determining one or more nature based noises that may be present in the audio data output from the user device of the first participant, e.g., birds in a predetermined navigation path, a waterfall, a volcano, wind of a relatively windy area, ocean waves, car traffic, etc.

Operation 212 includes monitoring, during the live web conference, audio and video data associated with participants of the live web conference, e.g., orally made by a participant, physically made by a participant, background noise of the participants, feedback from a user device of the first participant that is incorporated into audio and/or video data, etc. As mentioned elsewhere above, these participants include at least the first participant and the second participant. In some approaches, the monitoring is performed on data that has been captured on the user devices. In one or more of such approaches, this data may additionally and/or alternatively include data that is output from the user devices, e.g., subsequent to being captured by the user device. In some approaches, the audio and video data associated with the participants of the live web conference may additionally and/or alternatively include data that is based on behavior of one or more of the participants on the live web conference. For example, in some approaches, this behavior may be based on physical appearance of one or more of the participants, e.g., body posture, facial expressions, head shaking, putting arms up in the air, sighing, head nodding, etc. In some other approaches, this behavior may be based on one or more actions that one or more participants take with respect to a user device that they are using to virtually attend the live web conference, e.g., increasing a device volume output associated with another one of the participants, decreasing a device volume output associated with another one of the participants, muting another one of the participants, unmuting another one of the participants, increasing a designated video screen size associated with another one of the participants, decreasing a designated video screen size associated with another one of the participants, etc.

Data associated with the monitoring performed above may be captured in method 201. Furthermore, the first participant's behavior and/or audio and video data associated therewith is analyzed, e.g., see operation 214. In some preferred approaches, the first participant's behavior and/or audio and video data associated therewith is analyzed to determine whether to classify the first participant's behavior as being indicative of sound-aware actions. More specifically, for context, in some preferred approaches, the first participant's behavior and/or audio and video data associated therewith is analyzed in order to determine whether the first participant's behavior and/or audio and video data associated therewith is classified as unintended, e.g., unintended audio around the live web conference meeting such as background noise, or intended, e.g., intended audio around the live web conference meeting such as verbal sentences that the user intends the other participants to hear, e.g., see decision 216. Based on this analysis, the first participant's behavior and/or audio and video data associated therewith may be classified as either unintended or intended audio. Various approaches for performing such analyzing and classifying are described below, any one or more of which may be used to perform operation 214 and/or decision 216 of method 201.

In one approach, analyzing the first participant's behavior includes analyzing, using natural language processing (NLP), statements made by the first participant. Such statements may, in some approaches, be included as the audio and/or the video data captured by the user device of the first participant. For example, a first uttered phrase, e.g., a verbal phrase audibly expressed by the first participant, of the statements may be used to classify the first participant's behavior in some approaches. One or more techniques that would become apparent to one of ordinary skill in the art upon reading various descriptions herein may be used for performing NPL on the statements. In some approaches, it may be determined from results of performing NLP on the first uttered phrase includes a predetermined number of words. Accordingly, in some approaches, in response to a determination that the results of performing NLP on the first uttered phrase includes the predetermined number of words, the participant's behavior, e.g., speaking, and/or the audio and/or the video data captured by the user device of the first participant may be classified as intended audio, e.g., see “Intended audio” logical path of decision 216. In contrast, in some approaches in response to a determination that the results of performing NLP on the first uttered phrase do not include the predetermined number of words, the participant's behavior, e.g., speaking, and/or the audio and/or the video data captured by the user device of the first participant may be classified as unintended audio, e.g., see “Unintended audio” logical path of decision 216. In some approaches, the analysis and classification may additionally and/or alternatively be based on a determination of whether the words identified based on the performing NPL are related, e.g., have a at least a predetermined degree of relation, to a subject of the live web conference. Known techniques for comparing words and determining a degree of relation between the word samples may be used. The subject of the live web conference may be, e.g., determined from a title of a calendar invitation associated with the live web conference, received from a user device of a participant that created the live web conference, determined from emails determined to be associated with communications related to and prior to the live web conference, etc. In response to a determination that the words identified based on the performing NPL are related to the subject of the live web conference, the participant's behavior, e.g., speaking, and/or the audio and/or the video data captured by the user device of the first participant may be classified as intended audio. In contrast, in response to a determination that the words identified based on the performing NPL are not related to the subject of the live web conference, the participant's behavior, e.g., speaking, and/or the audio and/or the video data captured by the user device of the first participant may be classified as unintended audio.

Analyzing the first participant's behavior may, in some approaches, additionally and/or alternatively include identifying that the first participant has performed a predetermined sequence of actions that includes muting and unmuting a microphone of the first user device at least once during the live web conference. In some approaches, the analysis may be based on a determination of whether the first participant has performed the sequence of actions, e.g., at least a predetermined number of times, with at least a predetermined frequency, etc. Performing a sequence of actions that includes muting and unmuting a microphone of the first user device at least once during the live web conference may occur where the participant is concerned that their background noise is being included in audio data being output from the user device of the first participant to a user device of another participant, e.g., being translated to an audio feed being broadcasted on the user device of the second participant. More specifically, this sequence of actions may be the first participant attempting to prevent their audio feed from being heard by other participants during periods of time in which the first participant is not actively talking into a microphone of their user device. Accordingly, in some approaches, in response to a determination that the first participant has performed the predetermined sequence of actions, the participant's behavior, e.g., behavior associated with the predetermined sequence of actions, and/or the audio and/or the video data captured by the user device of the first participant may be classified as unintended audio. More specifically, in such an approach, audio data other than audio data corresponding to words detected by performing NLP may be classified as unintended audio. Accordingly, in some approaches, in response to a determination that the first participant has not performed the predetermined sequence of actions, the participant's behavior, e.g., behavior associated with the predetermined sequence of actions, and/or the audio and/or the video data captured by the user device of the first participant may be classified as intended audio.

Analyzing the first participant's behavior may in some approaches additionally and/or alternatively include analyzing metadata associated with the first participant. The metadata may, in some approaches, be metadata based on information obtained from monitoring operations described elsewhere herein. For example, the metadata may be based on information obtained and/or collected from monitoring the surrounding environment of the live web conference, e.g., see operation 210. The metadata may additionally and/or alternatively include, e.g., GPS information, raw noise data, processed noise data such as eliminated background noise, etc. One or more techniques that would become apparent to one of ordinary skill in the art upon reading various descriptions herein may be used for analyzing the metadata to determine whether the audio and/or video data associated with the metadata is related to the live web conference or not related to the live web conference. According to some more specific approaches, analyzing metadata that includes GPS information may include comparing the audio and/or video data to types of data determined to likely be present in the first participant's audio input based on a GPS location of the first participant. For example, assuming that it is determined that the first participant is located in an area within a predetermined proximity of where construction is occurring, analyzing the metadata may include comparing the metadata with predetermined construction noise samples to determine whether a predetermined degree of relation exists. In response to a determination that a predetermined degree of relation exists, the audio and/or video data associated with the metadata be classified as unintended audio around the live web conference. In contrast, in response to a determination that a predetermined degree of relation does not exist, the audio and/or video data associated with the metadata be classified as intended audio around the live web conference.

In some additional approaches, analyzing the first participant's behavior may additionally and/or alternatively include analyzing behavior, e.g., actions, of at least the second participant within the live web conference. In some approaches, in order to analyze the behavior of at least the second participant, data associated with the behavior of at least the second participant may be received. In contrast, the data associated with the behavior of at least the second participant may be captured and analyzed by the user device of the second participant, and results of the analysis may be output by the user device of the second participant and received by the user device of the first participant. In yet another approach, the data associated with the behavior of at least the second participant may be captured output by the user device of the second participant to a third device that is different that the first and second user device. The third device may be configured to analyze the data associated with the behavior of at least the second participant, and results of the analysis may be output by the third device and received by the user device of the first participant.

In some preferred approaches, the behavior of at least the second participant within the live web conference includes at least a volume control action performed on a user device of the second participant with respect to the first participant. For example, the first participant's behavior may be analyzed to determine whether the second participant performed an action that includes muting and/or turning down a volume level setting associated with the first participant on the user device of the second participant. Such an action may be performed by the second participant in response to the second participant perceiving an unpleasant amount of background noise in an audio feed associated with an output of the user device of the first participant. Other behavior actions of at least the second participant that may be analyzed to determine that the audio data of the first participant includes unintended audio include, e.g., the second participant shaking their head, the second participant taking their headphones off, the second participant wincing, the second participant rolling their eyes, etc.

In response to a determination that the behavior of at least the second participant within the live web conference includes the predetermined action, the participant's behavior, e.g., behavior associated with the predetermined sequence of actions, and/or the audio and/or the video data captured by the user device of the first participant may be classified as unintended audio. In contrast, in response to a determination that the behavior of at least the second participant within the live web conference does not include the predetermined action, the participant's behavior, e.g., behavior associated with the predetermined sequence of actions, and/or the audio and/or the video data captured by the user device of the first participant may be classified as intended audio.

With continued reference to FIG. 2, in response to determination that the audio data classifies as unintended audio around the meeting, e.g., as illustrated by the “Unintended audio” logical path of decision 216, method 201 continues to optional decision 218. Note that decision 218 is optional in that in some other approaches, the “Unintended audio” logical path of decision 216 may alternatively feed directly into decision 220. Decision 218 includes determining whether the unintended audio is contextually relevant to the live web conference. In some cases, unintended audio may be determined to be capable of positively contributing to the live web conference. In some approaches a predetermined table of potentially relevant sounds may be referenced for the determination, e.g., a notification bell, a dog barking, a noise having a pattern, etc. Furthermore, a predetermined table of potentially irrelevant sounds may be referenced for the determination, e.g., pots and pans clanking together, construction noise, feedback from a microphone, etc. In one illustrative approach, a dog barking in audio data output from the user device of the first participant is an example of audio that may be classified as unintended audio, but potentially capable of positively contributing to the live web conference. For example, in one approach, it may be determined that audio data received from the audio device of the second participant may be determined to include matching types of background noise, e.g., a dog barking, which may be a commonality shared between the first participant and the second participant. Such a commonality may prompt more personal conversations, e.g., sharing stories about their dogs. Accordingly, in response to a determination that unintended audio is contextually relevant to the live web conference, e.g., as illustrated by the “Yes” logical path of decision 218, the unintended audio may be retained in the audio and/or video data output from the user device of the first participant, and the method optionally continues to decision 220. In contrast, in response to a determination that unintended audio is not contextually relevant to the live web conference, e.g., as illustrated by the “No” logical path of decision 218, method 201 may include indicating, on the first user device of the first participant, a recommendation for improving the audio and/or the video data output from the first user device. For example, the recommendation may include a recommendation that the participant mute or unmute on the live web conference, e.g., see operation 228. This way, the unintended audio that may have otherwise decreased the audio quality heard while attending the live web conference, may optionally be excluded from the live web conference in response to receiving user input to do so.

Decision 220 includes determining whether the unintended audio that may be contextually relevant is noticeably audible. In some approaches, audio and/or video data output from the user device of the first participant may be analyzed using known techniques to determine whether the unintended audio is included therein. In some other approaches, it may be determined whether the unintended audio is noticeably audible by analyzing an audio output of the user device of the second participant to determine whether the unintended audio is included therein. In yet another approach, audio data and/or video data associated with the second participant may be analyzed for determining whether the unintended audio is included therein. For example, NLP may be performed on audio data received from the user device of the second participant to determine whether a predetermined string of words is present, e.g., “I can barely hear you over the background noise,” “What is that noise,” “Hold on, let me turn your volume down,” etc. In response to a determination from results of the analysis that the unintended audio is not noticeably audible, e.g., as illustrated by the “No” logical path of decision 220, predetermined information may be presented on the first user device of the first participant regarding the audio and/or the video data output from the first user device. For example, in operation 224, the predetermined information notifies the participant that the unintended audio of audio data of the first participant is not noticeably audible such as to the second participant. Accordingly, the first participant can participate unrestricted in the live web conference, e.g., participate unmuted in the live web conference without worrying about the unintended audio being heard by other participants on the live web conference. This clarity with live web conference participation is not otherwise enabled without the user having to query whether background noise is being experienced by the other participants. Accordingly, the techniques described herein proceed contrary to conventional wisdom and enable streamlined efficiencies in audio feeds of computer processing devices.

In some approaches it may be determined whether an alignment of participant behavior exists, e.g., see operation 222. For context, an alignment may be determined to exist between a participant's behavior and a current configuration of a user device in response to a determination that the participant appears to be satisfied with audio and/or video data being received from the first user device. In some preferred approaches, the satisfaction of a user such as the second participant may be determined based on predetermined queues of behavior of the second participant, e.g., such as the second user not adjusting a volume on their user device while the first participant's audio data is being played on the user device of the second participant. In contrast, it may be determined that an alignment does not exist between the second participant's behavior and a current configuration of a user device of the first participant. For example, assuming that current configurations of the first device are not filtering background noise out of the audio data associated with the first participant, the second participant may hear the background noise and appears to be unsatisfied, e.g., frown, adjust a volume on their user device while the first participant's audio data is being played on the user device of the second participant, etc., with audio and/or video data being received from the first user device. One or more techniques that would become apparent to one of ordinary skill in the art upon reading various descriptions herein may additionally and/or alternatively be used for gauging a satisfaction of the second user.

In response to a determination that an alignment of participant behavior exists between a participant, e.g., the second participant, and a current configuration of the first user device, e.g., as illustrated by the “Yes” logical path of decision 222, the method optionally continues to operation 230. In response to a determination that an alignment of participant behavior does not exist between a participant, e.g., the second participant, and a current configuration of the first user device, e.g., as illustrated by the “No” logical path of decision 222, information may be presented on the first user device of the first participant regarding the audio and/or the video data output from the first user device. For example, in one approach the information may notify the participant of misaligned device configuration and behavior, e.g., see operation 226.

The contextual information presented on the first user device in response to a determination that audio data of the first participant is unintended audio and/or in response to any one or other determinations being made under the “Unintended audio” logical path of method 201 will now be described in greater detail according to various approaches. For example, in some approaches, the information may additionally and/or alternatively indicate an amount of audio of the audio and/or the video data of the first participant that is reduced by a predetermined background noise elimination algorithm. Note that the predetermined background noise elimination algorithm may reduce such background noise before the audio and/or the video data is output from the first user device to the user device of the second participant, e.g., the second user device. In another approach, the information presented on the user device of the first participant may additionally and/or alternatively include a snippet of the audio and/or the video data output from the first user device to the second user device during the live web conference. In yet another approach, the information presented on the first user device may additionally and/or alternatively indicate a volume status of the second user device, e.g., whether the second participant muted the first participant or turned volume down a volume associated with the first participant's audio data on the second user device. One or more of these types of information may provide the first participant with context of whether or not to mute their audio feed in view of background noise that the first participant may be contributing to the live web conference. Furthermore, method 201 may optionally continue to operation 228 which includes indicating, on the first user device, a recommendation for improving the audio and/or the video data output from the first user device, e.g., muting and/or unmuting. This recommendation may be based on the information presented on the first user device. For example, assuming that the information presented on the first user device indicates that the misalignment of a current device configuration and the participant behavior, the recommendation may suggest that the first participant mute themselves to improve the live web conference, e.g., mitigate background noise that would otherwise be added to the live web conference.

Operation 230 includes enabling participant audio for participation. Enabling participant audio may include turning on a microphone and/or camera component of one or more of the user devices. These components may optionally be disabled, e.g., subsequent to receiving a participant input to mute one or more of such components. It may be determined whether the live web conference has concluded, e.g., see “Call concluded” of decision 232. Such a determination may include determining whether one or more of the participants are still participating on the live web conference. In response to a determination that the live web conference has not concluded, e.g., as illustrated by the “No” logical path of decision 232, the method optionally returns to operation 228. In contrast, in response to a determination that the live web conference has concluded, e.g., as illustrated by the “Yes” logical path of decision 232, the knowledge corpus may be updated, e.g., see operation 234 with any of the data and/or results of the analysis obtained in one or more operations of method 201. Thereafter, method 201 may optionally end, e.g., see “End.”

For purposes of additional context, various examples of use cases of the techniques of method 201 will now be described below.

A first use case involves a first participant assuming that they are contributing background noise to a live web conference, while in actuality, other participants, e.g., the second participant, cannot hear such background noise. It may be assumed that the first participant is joining their customer meeting via a live web conference application. At the time that the first participant joins the live web conference, there is loud construction occurring right outside of the window. Accordingly, the first participant enables a mute feature of the application thinking that other participants will be distracted and hearing the background noise through the first participant's audio. The first participant may furthermore continually turn their head to look out the window and check on the progress of the construction, e.g., in order to see if the construction will be over in the relatively near future. At this point, the first participant may opt-in to use a module configured to implement various techniques described herein for determining and presenting contextual information regarding audio and/or video data output from a first user device of the first participant. The module may be implemented on the first user device in some approaches. The module may detect the first participant's visual image consistently looking away from a camera of the first device, and also detect the construction noise in the background. The module may confirm that the web conferencing technology hosting the live web conference is cancelling the noise for other participants in the live web conference. Contextual information may be presented on the first user device regarding the audio and/or the video data output from the first user device. For example, the first participant may be provided with a notification that the other participants of the live web conference are not able to hear the construction noise. The first participant would not otherwise know this information without asking the other participants, which would ultimately interrupt the focus of the conversation. Accordingly, by being provided with such contextual information, the first participant is then able to unmute and actively participate in the conversation. In one preferred approach, the contextual information may include a visual flag that is presented on a display of the first device of the first participant in response to a determination that the first participant is a nuisance to other participants based on the first participant's behavior of muting/unmuting their audio.

A second use case involves a first participant not thinking that there is background noise in their audio output while there actually is, e.g., thereby experienced as feedback by at least a second participant on a live web conference with the first participant. It may be assumed that the first participant is joining their customer meeting via a live web conference application. Because the first participant does not hear any background noise, the first participant does not mute themselves while the second participant is presenting. At this point, the first participant may opt-in to use a module configured to implement various techniques described herein for determining and presenting contextual information regarding audio and/or video data output from a first user device of the first participant. The module may be implemented on the first user device in some approaches. The module may provide contextual information to the first participant that other participants on the live web conference can hear feedback and echo from audio data output from the first user device. The module may additionally recommend that the first participant mute themselves. With this information, the first participant is then able to mute themselves and not disrupt the flow of the second participant's presentation.

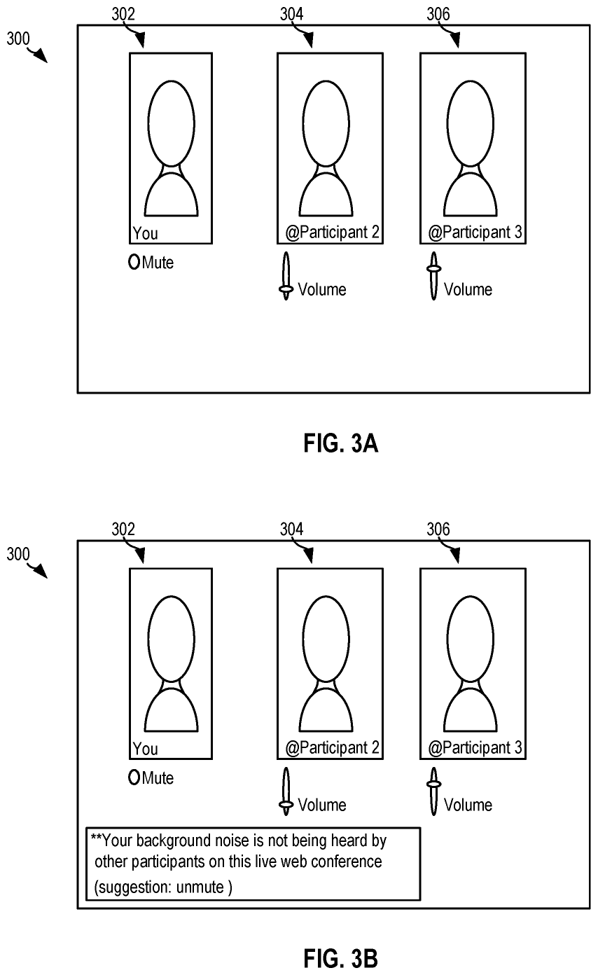

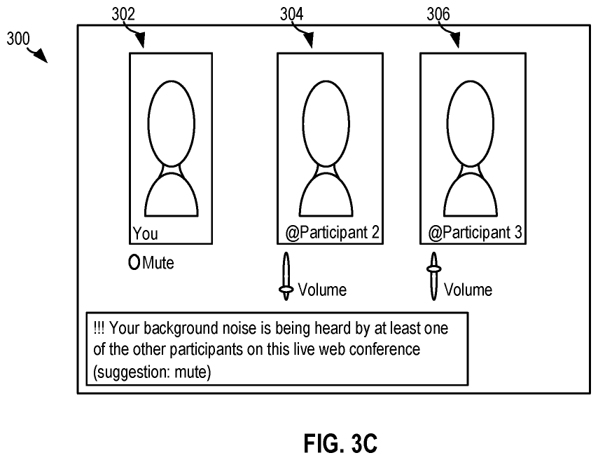

FIGS. 3A-3C depict a user device display 300, in accordance with one embodiment. As an option, the present user device display 300 may be implemented in conjunction with features from any other embodiment listed herein, such as those described with reference to the other FIGS. Of course, however, such user device display 300 and others presented herein may be used in various applications and/or in permutations which may or may not be specifically described in the illustrative embodiments listed herein. Further, the user device display 300 presented herein may be used in any desired environment.

It may be prefaced that the user device display 300 may be used by a first participant, e.g., see You, while on a live web conference with at least one other participant, e.g., see second participant “@Participant 2” and third participant “@Participant 3”. The user device display 300 may be configured to perform one or more operations described in various embodiments and approaches described herein to provide the first participant information about their background noise in relation to not just intelligibility but negative affects with context of noise assistance modules. The module is preferably able to process and gauge participant interactions to classify them as being indicative of audio aware and providing participant context of actual negative impact. Furthermore, the module may gauge and/or capture other participant behavior to help understand a degree of negative impact on other attendees of the live web conference. In some approaches, a visual flag is presented to the first participant in response to a determination that the first participant is a nuisance to other participants based on the first participant's behavior of muting/unmuting their audio. Such as flag may additionally and/or alternatively be presented to the user based on NLP extraction of statements of the first participant that identify apologies for background noise which may or may not be heard by other participants on the live web conference. In some approaches, the module may additionally and/or alternatively be configured to learn of and renotify the first participant in response to a determination that a relatively quality of audio data output from and/or output by a device of the first participant degrades or increases. An audio sample may additionally and/or alternatively be played back to the first participant enabling the user to make a manual decisioning of an impact of their behavior and/or audio and video data.

With reference now to FIG. 3A, the user device display 300 includes graphical icons 302, 304 and 306 that each represent different participants on the call. Furthermore, the user device display 300 includes selectable icons to adjust the volume outputs associated with each of the participants, e.g., see Mute and Volume.

In some approaches, the first participant may opt into the module to allow categorization and processing of audio from the user device display 300 on a collaborative platform. As the first participant joins the live web conference with audio processing, the module may be initiated, e.g., kicks off. The module may perform monitoring on the first participant's interactions to categorize if the behavior is indicative of sound-aware actions. According to various approaches, sound aware actions and patterns include, but are not limited to, e.g., a participant going on and off mute; participant NLP statements such as “Sorry for the background noise,” etc.; additional metadata from the user device of a participant including but not limited to GPS information; raw noise data; processed noise including background eliminated noise; counter behaviors such as other participants muting or turning down a volume output associated with another one of the participants, etc.

In some approaches, subsequent to flagging behavior of one or more of the participants, the module may look for indicative patterns and set a flag. For context, this flag is only visible by the first participant or allowed participants such as a host of the live web conference. The flagged module may provide information such as, e.g., an amount of audio reduced, an intelligibility score which may indicate an accuracy of the analysis of the behavior, a snippet of audio associated with the first participant to be played back when the first participant is on mute, etc.

The first participant may be presented with information regarding the audio and/or the video data output from the first user device. This information allows the first participant to see either machine contextualized information or self-contextualize if the context of their muting is necessary as the audio is self-managed. For example, referring now to FIG. 3B, information presented on the user device display 300 informs the first participant that their background noise is not being heard by other participants on the live web conference. The information furthermore includes a context based recommendation, e.g., see suggestion: unmute. In some approaches, it is recommended that the first participant does not mute because the other participants might be prompted for similarities, connection or understanding. For example, assuming that the first participant has a dog barking in the background during a live web conference, the first participant may be alerted that another one of the participants on the live web conference also has dog barking in their background noise at times, e.g., in order to indicate that this could be a commonality. Similar examples include music playing, transportation noises, etc., which may enable a talking point that highlights a commonality between two or more participants on the same live web conference.

In some approaches, the module may learn from previous analysis, e.g., iteratively incorporating feedback into a processing engine of the module, and play back patterned details to the first participant to inform them of the audio information affecting the intelligibility score of other users. Some approaches may additionally and/or alternatively incorporate predictions of future noise event(s) based on a predetermined known event knowledge corpus: For example, within types of events that occur within a timed pattern or due to various interactions with the first participant's environment, predictions of the interaction with the environment may be made, e.g., a noisy event that is about to occur may be predicted. An illustrative use case example of this is a cuckoo clock chiming and providing a loud interaction within the first participant's environment, e.g., once or twice per hour. This noise event may be predicted within the first participant's environment with precision, and incorporated into the information presented to the user, e.g., a recommendation to mute that is presented to the user a predetermined amount of time before the chime occurs, a countdown to chime displayed on the user device display 300, etc.

Referring now to FIG. 3C, information presented on the user device display 300 informs the first participant that their background noise is being heard by at least one of the other participants on this live web conference. The information furthermore includes a context based recommendation, e.g., see suggestion: mute.

It will be clear that the various features of the foregoing systems and/or methodologies may be combined in any way, creating a plurality of combinations from the descriptions presented above.

It will be further appreciated that embodiments of the present invention may be provided in the form of a service deployed on behalf of a customer to offer service on demand.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method, comprising:
monitoring, during a live web conference, audio and video data associated with participants of the live web conference, wherein the participants include at least a first participant and a second participant;
analyzing the first participant's behavior to determine whether to classify the first participant's behavior as being indicative of sound-aware actions; and
presenting information, based on the analysis, on a first user device of the first participant regarding audio and/or video data output from the first user device.

2. The computer-implemented method of claim 1, wherein analyzing the first participant's behavior includes: analyzing, using natural language processing (NLP), statements made by the first participant, wherein a first uttered phrase of the statements is used to classify the first participant's behavior.

3. The computer-implemented method of claim 1, wherein analyzing the first participant's behavior includes: identifying that the first participant has muted and unmuted a microphone of the first user device at least once during the live web conference.

4. The computer-implemented method of claim 1, wherein analyzing the first participant's behavior includes: analyzing metadata associated with the first participant, wherein the metadata is selected from the group consisting of: global positioning system (GPS) information, raw noise data, and processed noise data.

5. The computer-implemented method of claim 1, wherein analyzing the first participant's behavior includes: analyzing behavior of at least the second participant within the live web conference, wherein the behavior of at least the second participant within the live web conference includes a volume control action performed on a second user device of the second participant with respect to the first participant.

6. The computer-implemented method of claim 1, wherein the information presented on the first user device indicates an amount of audio reduced by a predetermined background noise elimination algorithm.

7. The computer-implemented method of claim 1, wherein the information presented on the first user device includes a snippet of the audio and/or the video data output from the first user device to a second user device of the second participant during the live web conference.

8. The computer-implemented method of claim 1, wherein the information presented on the first user device indicates a volume status of a second user device of the second participant regarding the first participant.

9. The computer-implemented method of claim 1, wherein the information presented on the first user device indicates that unintended audio in audio data associated with the first participant is not noticeably audible to the second participant.

10. The computer-implemented method of claim 1, comprising: indicating, on the first user device of the first participant, a recommendation for improving the audio and/or the video data output from the first user device.

11. A computer program product, the computer program product comprising a computer readable storage medium having program instructions embodied therewith, the program instructions readable and/or executable by a computer to cause the computer to:
monitor, by the computer, during a live web conference, audio and video data associated with participants of the live web conference, wherein the participants include at least a first participant and a second participant;
analyze, by the computer, the first participant's behavior to determine whether to classify the first participant's behavior as being indicative of sound-aware actions; and
present information, by the computer, based on the analysis, on a first user device of the first participant regarding audio and/or video data output from the first user device.

12. The computer program product of claim 11, wherein analyzing the first participant's behavior includes: analyzing, using natural language processing (NLP), statements made by the first participant, wherein a first uttered phrase of the statements is used to classify the first participant's behavior.

13. The computer program product of claim 11, wherein analyzing the first participant's behavior includes: identifying that the first participant has muted and unmuted a microphone of the first user device at least once during the live web conference.

14. The computer program product of claim 11, wherein analyzing the first participant's behavior includes: analyzing metadata associated with the first participant, wherein the metadata is selected from the group consisting of: global positioning system (GPS) information, raw noise data, and processed noise data.

15. The computer program product of claim 11, wherein analyzing the first participant's behavior includes: analyzing behavior of at least the second participant within the live web conference, wherein the behavior of at least the second participant within the live web conference includes a volume control action performed on a second user device of the second participant with respect to the first participant.

16. The computer program product of claim 11, wherein the information presented on the first user device indicates an amount of audio reduced by a predetermined background noise elimination algorithm.

17. The computer program product of claim 11, wherein the information presented on the first user device includes a snippet of the audio and/or the video data output from the first user device to a second user device of the second participant during the live web conference.

18. The computer program product of claim 11, wherein the information presented on the first user device indicates a volume status of a second user device of the second participant regarding the first participant.

19. The computer program product of claim 11, wherein the information presented on the first user device indicates that unintended audio in audio data associated with the first participant is not noticeably audible to the second participant.

20. A system, comprising:
a processor; and
logic integrated with the processor, executable by the processor, or integrated with and executable by the processor, the logic being configured to:
monitor during a live web conference, audio and video data associated with participants of the live web conference, wherein the participants include at least a first participant and a second participant;
analyze the first participant's behavior to determine whether to classify the first participant's behavior as being indicative of sound-aware actions; and
present information, based on the analysis, on a first user device of the first participant regarding audio and/or video data output from the first user device.
